(19) United States
(12) Patent Application Publication
(10) Pub. No.: US 2025/0028261 A1
(43) Pub. Date: Jan. 23, 2025

(54) PRINTING EQUIPMENT FOR METAL MATERIAL HAVING EXCELLENT PRINT QUALITY, PRINTING METHOD AND PRINTED METAL MATERIAL OBTAINED THEREFROM

(71) Applicant: POSCO CO., LTD, Pohang-si, Gyeongsangbuk-do (KR)

(72) Inventor: Sun-Hong Park, Pohang-si, Gyeongsangbuk-do (KR)

(73) Assignee: POSCO CO., LTD, Pohang-si, Gyeongsangbuk-do (KR)

(21) Appl. No.: 18/577,156

(22) PCT Filed: Jul. 11, 2022
(86) PCT No.: PCT/KR2022/010058

§ 371 Date: Oct. 10, 2024

(30) Foreign Application Priority Data
Jul. 12, 2021 (KR) 10-2021-0090917

(51) Int. Cl. G03G 15/01; G03G 15/08; G03G 15/16; G03G 15/20; G03G 21/00; G03G 21/06; G03G 21/12

(52) U.S. Cl. CPC G03G 15/0189; G03G 15/0121; G03G 15/0131; G03G 15/0806; G03G 15/161; G03G 15/1615; G03G 15/1695; G03G 15/2064; G03G 21/0011; G03G 21/06; G03G 21/12

(57) ABSTRACT

The present invention relates to technology for printing an image such as a letter, a picture, or the like on a surface of a metal material, including printing equipment capable of stably printing the image on the surface of the metal material at high speed, a printing method using the same, and a printed metal material obtained therefrom.

### TECHNICAL FIELD

The present disclosure relates to printing equipment for printing an image such as a letter, a picture, or the like on a surface of a metal material such as a steel sheet or the like, a printing method using the same, and a printed metal material obtained therefrom.

### BACKGROUND ART

A method for printing an image such as a letter, a picture, or the like on a surface of a metal material includes a polymer transfer process, a roll transfer process, and an inkjet spray printing process.

The polymer transfer process may output an image film having a sheet shape, and may transfer an image to a surface of a metal using an operation such as thermal transfer, chemical transfer, or the like. In the operation of transferring the image to the surface of the metal using the film, it may be free to output on the film, but there may be disadvantages that a speed of preparing the same decreases as the film is transferred to a steel sheet, and the image having a film shape attached to the surface of the metal may be changed depending on a temperature or a weather.

The roll transfer process may form a certain pattern on a surface of a roll, and may transfer an image to a surface of a metal material using a roll-to-roll process. However, the transferred image may be limited to an image having repetitive patterns, and in order to use the roll transfer process, since a roll having a patterned image should be prepared, it is difficult to prepare a patterned roll each time for various images.

The inkjet spray printing process may print an image or a letter on a surface of a metal material using a liquid ink containing a pigment and a polymer resin. When the inkjet spray printing process uses the liquid ink, there may be a problem that the surface of the metal material should be plasma treated or surface roughness thereof should be controlled such that the liquid may be well adsorbed on a surface of a steel sheet. In addition, since the inkjet spray printing process uses liquid ink, clogging may occur in a nozzle through which ink is sprayed, requiring not only management of the nozzle but also periodic cleaning and replacement of the nozzle. In addition, since the liquid ink is used, stabilization after injection of the ink may be essential, and it is difficult to manufacture using a roll-to-roll process. Accordingly, use thereof is limited to a batch type. In particular, since a material of the inkjet spray printing process may be formed in a manner in which liquid polymers are connected and pigments form an image therein, there may be a problem that a printed image may peel off when bending or cutting.

Recently, a metal material is used in various fields, and an image such as a letter, a picture, or the like is increasingly applied to a surface of the metal material. However, the existing image printing process may print on a surface of a paper, a polymer material, or the like, and there may be technical and production limitations in applying the same to the surface of the metal material. Accordingly, there may be a need for a method to solve the limitations of the conventional printing method.

Additionally, since a metal material has a unique color, when printing on a surface of the metal material, an image may not be clear. Therefore, a demand for a method having excellent printing quality on the surface of the metal material is increasing.

### SUMMARY OF INVENTION

### Technical Problem

An aspect of the present disclosure is to provide technology for printing an image such as a letter, a picture, or the like on a surface of a metal material, including printing equipment capable of stably printing the image on the surface of the metal material at high speed, a printing method using the same, and a printed metal material obtained therefrom.

In addition, another aspect of the present disclosure relates to printing equipment capable of improving quality of printing formed on a metal material, a printing method using the same, and a printed metal material obtained therefrom.

An object of the present disclosure is not limited to the above-mentioned matters. Additional problems of the present disclosure described are throughout the specification, and those skilled in the art will have no difficulty in understanding the additional problems of the present disclosure from the contents described in the specification of the present disclosure.

### Solution to Problem

An aspect of the present disclosure provides printing equipment having excellent printing quality, including
preprinting equipment (1000 and 1000′) printing a white image on a surface of a metal material 100, which is continuously moving; and
main printing equipment (2000 and 2000′) printing an image on a surface of the metal material 100 on which the white image is printed.

Another aspect of the present disclosure provides a printing method having excellent printing quality, including
a preprinting operation of printing a white image on a surface of a metal material 100, which is continuously moving; and
a main printing operation of printing an image on a surface of the metal material 100 on which the white image is printed.

Another aspect of the present disclosure provides a printed metal material having excellent printing quality, including
a metal material;
a white image layer formed on the metal material; and
a printing layer formed on the white image layer.

### Advantageous Effects of Invention

The present disclosure provides technology for stably printing an image such as a letter, a picture, or the like on a surface of a metal material, and may improve product production efficiency by continuously preparing the same. Additionally, there are advantages of being able to manufacture high value-added products by easily forming diverse and colorful images.

Moreover, there are advantages of ensuring excellent printing quality as a printed image is clear without being interfered with by an inherent color of a metal material.

Various advantages and effects of the present disclosure are not limited to the above-described contents, and can be more easily understood through description of specific embodiments of the present disclosure.

### BRIEF DESCRIPTION OF DRAWINGS

FIG. 1 is a schematic diagram schematically illustrating an embodiment of printing equipment of the present disclosure.

FIG. 2 is a schematic diagram specifically illustrating an embodiment of preprinting equipment in printing equipment of the present disclosure.

FIG. 3 is a schematic diagram specifically illustrating another embodiment of preprinting equipment in printing equipment of the present disclosure.

FIG. 4 is a schematic diagram specifically illustrating an embodiment of main printing equipment in printing equipment of the present disclosure.

FIG. 5 is a schematic diagram specifically illustrating another embodiment of main printing equipment in printing equipment of the present disclosure.

FIG. 6 is a schematic diagram specifically illustrating an embodiment of a laser exposure unit in printing equipment of the present disclosure.

FIG. 7 is a schematic diagram specifically illustrating an embodiment of a remover in printing equipment of the present disclosure.

FIG. 8 is a schematic diagram specifically illustrating another embodiment of main printing equipment in printing equipment of the present disclosure.

FIG. 9 is a schematic diagram specifically illustrating another embodiment of main printing equipment in printing equipment of the present disclosure.

FIG. 10 is a schematic diagram schematically illustrating a cross-section of a printed metal material of the present disclosure.

FIG. 11 illustrates an image printed on a metal material. In portion (a), the image is printed on a white image layer, and in portion (b), the image is printed without a white image layer.

### BEST MODE FOR INVENTION

Terms used in the specification are for describing the present disclosure, and are not intended to limit the present disclosure. Additionally, as used herein, a singular form may include a plural form, unless relevant definition clearly indicates the contrary.

Meaning of “including” used in the specification specifies a configuration, and does not exclude the presence or addition of another configuration.

Unless otherwise defined, all terms, including technical and scientific terms, used in the specification have the same meaning as commonly understood by a person of ordinary skill in the technical field to which the present disclosure pertains. Terms defined in the dictionary are interpreted to have meanings consistent with related technical literature and current disclosure.

Laser or LED printing, generally known, is for printing on a flexible object such as a paper or the like, but the present disclosure relates to technology for printing an image on a metal material. In order to print on a surface of a metal material, which is continuously moving, using a roll-to-roll process or the like, the present disclosure relates to printing equipment in which components, such as an charging unit, a photosensitive drum, a fused roll, and the like are configured in a traveling direction of the metal material, and a printing method using the same.

In particular, according to the present disclosure, not only diverse and complex images, but also images of various colors may be easily and economically implemented, compared to a printing method on an existing metal material.

Meanwhile, a metal material may often have a unique color thereof. Therefore, even when an image is printed on a surface thereof, not all images may be clear. In other words, printing quality may deteriorate. Therefore, superior printing quality may be secured by the inventors of the present disclosure by way of first printing (preprinting) a white image on a surface of a metal material before printing the image on the metal material, and then printing (main printing) a desired image, using the printed white image as a background.

Hereinafter, preferred embodiments of the present disclosure will be described with reference to the drawings. Embodiments of the present disclosure may be modified in various forms, and should not be construed as being limited to the drawings and embodiments described below, and may be provided for being described in detail to those skilled in the art to which the present disclosure pertains.

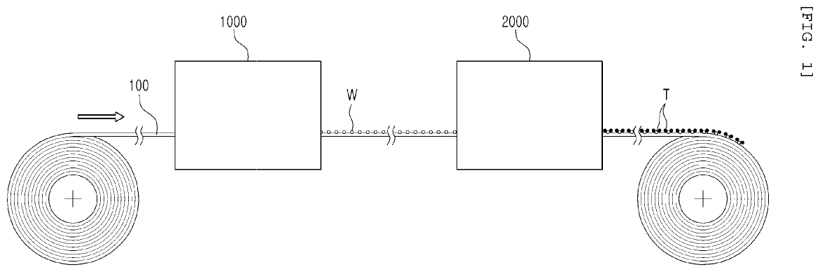

FIG. 1 schematically illustrates an embodiment of printing equipment of the present disclosure. Referring to FIG. 1, printing equipment of the present disclosure may be, as an example, printing equipment printing a white image on a surface of a metal material 100, which is continuously moving, by a roll-to-roll process or the like, and may include preprinting equipment (1000 and 1000′) printing a white image on a surface of a metal material 100, which is continuously moving; and main printing equipment (2000 and 2000′) printing an image on a surface of the metal material 100 on which the white image is printed.

The image refers to a letter, a pattern, a picture, or the like, may have various forms such as a solid color, an achromatic color, a chromatic color, a three-dimensional shape, or the like, but the white image refers to that implemented as a single white color.

There are advantages in that the white image may be formed on the surface of the metal material 100 through the preprinting equipment (1000 and 1000′), and before the image is printed by the main printing equipment (2000 and 2000′), the white image may be formed on the surface of the metal material 100 to secure clarity in which the image of the main printing is excellent.

First, the preprinting equipment (1000 and 1000′) will be described in detail.

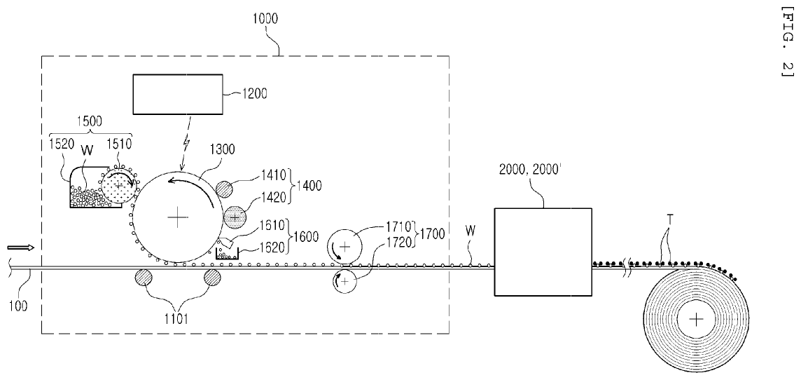

FIG. 2 illustrates an example of the preprinting equipment 1000. Referring to FIG. 2, a preprinting equipment 1000 may include a preprinting photosensitive drum 1300, a preprinting photosensitive drum charging unit 1410, a preprinting photosensitive drum discharging unit 1420, a preprinting exposure unit 1200, a preprinting developer 1500, a preprint metal material charging unit 1101, a preprinting remover 1600, a preprinting fixer 1700, or the like. Hereinafter, each configuration will be described in detail with reference to FIG. 2.

The preprinting photosensitive drum 1300 may transfer and settle a white toner W attached to a surface of the preprinting photosensitive drum 1300, to and on a surface of the metal material 100, while closely contacting the surface of the metal material 100 to rotate in one direction, to transfer an image. Although the preprinting photosensitive drum 1300 is illustrated in FIG. 2 as rotating in one direction, the preprinting photosensitive drum 1300 does not necessarily rotate in only one direction, and may also rotate in both directions. The preprinting photosensitive drum 1300 may be sufficient as long as it is commonly used in the technical field to which the present disclosure pertains, and a type thereof is not particularly limited. As a preferred example thereof, an organic photo conductor (OPC) drum may be used.

The preprinting developer 1500 may be provided on one side of the preprinting photosensitive drum 1300, and may provide the white toner W for forming an image on a surface thereof. The preprinting developer 1500 may be sufficient as long as it provides the white toner W to the preprinting photosensitive drum 1300, and a form or shape thereof is not particularly limited. In FIG. 2, as a preferred example, the preprinting developer 1500 may include a toner container 1520 containing the white toner W, and a developing roller 1510 transferring the white toner from the toner container 1520 to the preprinting photosensitive drum 1300. The developing roller 1520 may not be essential, and in some cases, the white toner W may be provided directly from the toner container 1520 to the preprinting photosensitive drum 1300. The white toner W may be used to form a white image on the surface of the metal material.

The preprinting photosensitive drum charging unit 1410 for charging a surface of the preprinting photosensitive drum 1300, before the white toner W is provided, may be included. The preprinting photosensitive drum charging unit 1410 may apply an electrostatic charge to the surface of the preprinting photosensitive drum. A corona wire may be usually used as a means of charging.

The preprinting exposure unit 1200 applying light energy to the charged surface of the preprinting photosensitive drum 1300 according to a required image, between the preprinting developer 1500 and the preprinting photosensitive drum charging unit 1410, may be provided. A position of the preprinting exposure unit 1200 may not be important, but the light energy may be imparted to a surface of the photosensitive drum 3100 between the preprinting developer 1500 and the preprinting photosensitive drum charging unit 1410. Due to the light energy, some charges may be removed from the surface of the preprinting photosensitive drum 1300, and the toner may be attached to the surface of the preprinting photosensitive drum 1300 by the preprinting developer 1500. The light energy is preferably provided by a laser or a light emitting diode (LED).

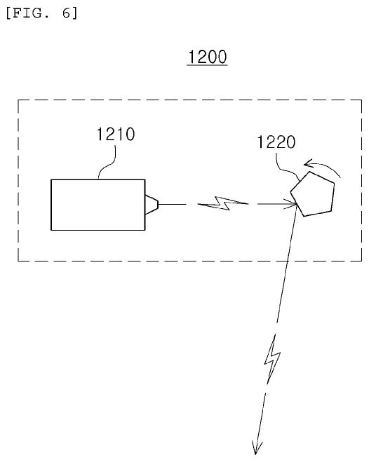

FIG. 6 schematically illustrates a preprinting exposure unit 1200 when using the laser, and may include a laser generator 1210, and a scanning mirror 1220 controlling the laser coming from the laser generator 1210 and removing an charge by scanning according to a desired image on the surface of the preprinting photosensitive drum 1300. A structure of FIG. 6 may be applied in a principle, identical to those of a exposure unit (1200, 1200′, 2200, 2200′, 2201, 2201′, 2202, 2202′, 2203, 2203′, 2204, and 2204′).

The preprinting metal material charging unit 1101 charging the surface of the metal material 100 to move and settle the white toner W attached to the surface of the preprinting photosensitive drum 1300, to the surface of the metal material 100, may be included. The preprinting metal material charging unit 1101 may not only serve to charge the metal material 100 with a certain charge, but also serve as a guide roll to assist the metal material move at a constant speed. At least one preprinting metal material charging unit 1101 may be provided, and the preprinting metal material charging unit 1101 may be formed on a front end, a rear end, or front and rear ends of the preprinting photosensitive drum 1300 based on a traveling direction of the metal material 100, and may be located on an upper portion, a lower portion, or both upper and lower portions of the metal material 100. Even when there are two or more preprinting metal material charging unit 1101, they may not play different roles, and there may be advantages in that stronger electrostatic attraction may be secured by charging two or more times.

A coating layer, for example, a resin layer or the like may be separately formed on the surface of the metal material 100, and when printing on the coating layer, a preprinting metal material charging unit 1101 charging the coating layer may be located on an upper portion of the coating layer. The metal material charging unit located on the upper portion of the coating layer may be applied in the same principle not only in the preprinting equipment (1000 and 1000′) but also in the main printing equipment (2000 and 2000′), described later.

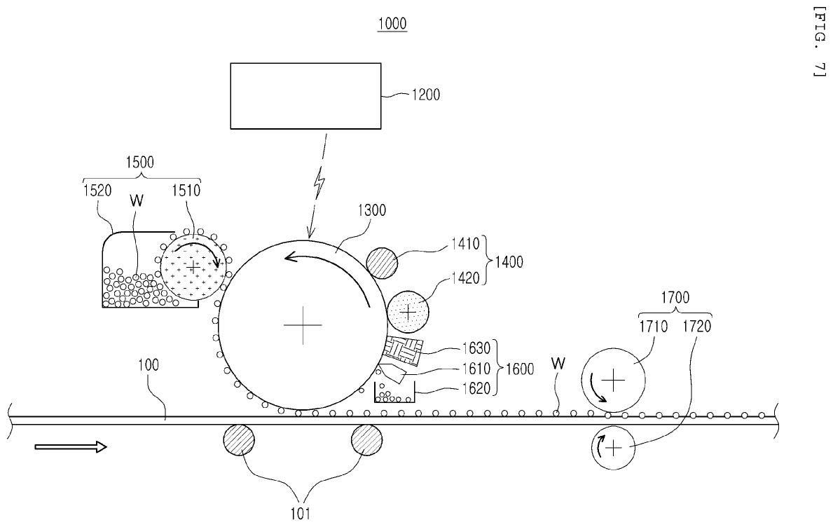

The preprinting remover 1600 removing the white toner W remaining on the surface of the preprinting photosensitive drum 1300, after the white toner W is settled on the surface of the metal material 100, may be included. The preprinting remover 1600 may include a blade 1610 for separating the portion of the toner remaining on the surface of the preprinting photosensitive drum 1300, and a collection bin 1620 for collecting the separated toner in a lower end of the blade 1610, to prevent the separated toner from falling onto the metal material 100 to deteriorate printing quality. FIG. 7 may be a more detailed illustration of the remover 1600 for removing the toner remaining on the surface of the preprinting photosensitive drum 1300. In addition to the blade 1610 and the collection bin 1620 described above, an alcohol brush 1630 may be further included. The preprinting photosensitive drum 1300 may rotate at high speed and transfer the image, and, thus, may not be easy to remove the toner. In this case, there may be a problem that an afterimage of the image may remain. To this end, after primary removal using the blade 1610, secondary removal may be performed by a chemical method using the alcohol brush 1630 or the like. The same structure and principle of the blade, the collection bin, and the alcohol brush may be applied to the preprinting equipment (1000 and 1000′) as well as the main printing equipment (2000 and 2000′).

After the white toner W is settled on the metal material, the preprinting fixer 1700 for stably forming an image by fixing the white toner W on the metal material 100 may be provided on a rear end of the preprinting photosensitive drum 1300 based on a traveling direction of the metal material 100. The preprinting fixer 1700 may include a fused roll 1710 applying heat to the white toner W to fix the white toner W settled on the metal material 100, and a pressure roll 1720 applying pressure to assist fixation of the white toner W. In this case, a heating temperature of the fused roll 1710 may be 25 to 400° C. The same structure and principle of configurations of the fixation unit, the fused roll, and the pressure roll may be applied not only to the preprinting equipment (1000 and 1000′) but also to the main printing equipment (2000 and 2000′), described later.

In the present disclosure, it is more preferable that the metal material charging unit (1101, 1101′, 2101, and 2101′) and the pressure roll (1720, 1720′, 2720, and 2720′) have a structure capable of moving in upward and downward directions. The metal material 100 may not always have a constant thickness, and may be a very thin film or a thick plate. Therefore, when the metal material charging unit (1101, 1101′, 2101, and 2101′) and the pressure roll (1720, 1720′ 2720, and 2720′) have a variable structure and move in upward and downward directions, depending on a thickness of the metal material 100, the image may be printed regardless of the thickness of the metal material 100.

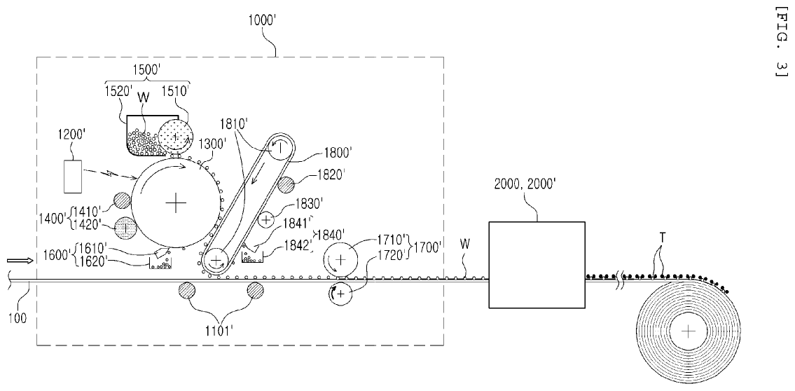

FIG. 3 illustrates another example of a preprinting equipment 1000′ in the present disclosure. Referring to FIG. 3, a preprinting equipment 1000′ may include a preprinting transfer belt 1800′, a preprinting photosensitive drum 1300′, a preprinting photosensitive drum charging and discharging unit 1400′, a preprinting exposure unit 1200′, a preprinting developer 1500′, a preprinting remover 1600′, a preprinting fixer 1700′, or the like. Hereinafter, each configuration will be described in detail with reference to FIG. 3.

The preprinting transfer belt 1800′ may transfer and settle a white toner W attached to a surface of the preprinting transfer belt 1800′, to and on a surface of a metal material 100, while closely contacting the metal material 100 to rotate in one direction, and, at the same time, may play a role in protecting a surface of the preprinting photosensitive drum 1300′ and improving quality of an image. When hardness of the metal material 100 is high, the surface of the preprinting photosensitive drum 1300′ may be damaged due to contact between the metal material 100 and the preprinting photosensitive drum 1300′. In this case, repair and replacement costs for the preprinting photosensitive drum 1300′ may increase, and accuracy of the transferred image may also deteriorate, to deteriorate printing quality. A method in which the toner does not move from the preprinting photosensitive drum 1300′ to the metal material 100, but transferred via the preprinting transfer belt 1800′, may be adopted.

A driving roll 1810′ of the preprinting transfer belt may be provided to drive the preprinting transfer belt 1800′ in a traveling direction, a charger 1820′ of the preprinting transfer belt may be provided to charge a surface of the preprinting transfer belt 1800′ before receiving the white toner W from the preprinting photosensitive drum 1300′, and a corona wire may be usually frequently used. After the white toner W of the preprinting transfer belt 1800′ is transferred to the metal material 100 to transfer the image, a toner remover 1840′ for removing the white toner W remaining on the transfer belt may be provided, and a discharging unit 1830′ of the preprinting transfer belt for discharging an charge of the transfer belt, after the toner W is removed, may be provided. A device for driving the preprinting transfer belt 1800′ may be substantially identical to equipment for driving a main printing transfer belt 2800′, which will be described later.

The preprinting photosensitive drum 1300′ may transfer the white toner W attached to a surface of the preprinting photosensitive drum 1300′, to the surface of the preprinting 1800′, while closely contacting the transfer belt preprinting transfer belt 1800′ to rotate in an opposite direction. The preprinting photosensitive drum 1300′ may be sufficient as long as it is commonly used in the technical field to which the present disclosure pertains, and a type thereof is not particularly limited. As a preferred example thereof, an organic photo conductor (OPC) drum may be used.

The preprinting developer 1500′ may be provided on one side of the preprinting photosensitive drum 1300′, and may provide the white toner W for forming an image on a surface thereof. The preprinting developer 1500′ may be substantially identical to those of the preprinting equipment of FIG. 2, and the detailed description thereof may be replaced with the above-described contents.

A preprinting photosensitive drum charging unit 1410′ for charging the surface of the photosensitive drum 1300′, before the white toner W is provided, may be included. The preprinting photosensitive drum charging unit 1410′ may apply an electrostatic charge to a surface of the photosensitive drum. As the charging unit, a corona wire may be usually used.

The preprinting exposure unit 1200′ applying light energy to the charged surface of the preprinting photosensitive drum 1300′ according to a required image, between the preprinting developer 1500′ and the preprinting photosensitive drum charging unit 1410′ may be provided. A position of the preprinting exposure unit 1200′ may not be important, but the light energy may be imparted to a surface of the preprinting photosensitive drum 1300′ between the preprinting developer 1500′ and the preprinting photosensitive drum charging unit 1410′. Since a specific function and structure of the preprinting exposure unit 1200′ may not be different from the preprinting exposure unit 1200 previously described with reference to FIGS. 2 and 6, the above-described contents may be replaced.

The preprinting metal material charging unit 1101′ charging the surface of the metal material 100 to move and settle the white toner W attached to the surface of the preprinting photosensitive drum 1300′, to the surface of the metal material 100, may be included. The preprinting metal material charging unit 1101′ may not only serve to charge the metal material a certain charge, but may also serve as a guide roll to assist the metal material move at a constant speed. At least one preprinting metal material charging unit 1101′ may be provided, and the preprinting metal material charging unit 1101′ may be formed on a front end, a rear end, or front and rear ends of the transfer belt 1800′ based on a traveling direction of the metal material 100, and may be located on an upper portion, a lower portion, or both upper and lower portions of the metal material 100.

Even when there are two or more preprinting metal material charging unit 1101′, they do not play different roles, and there may be an advantage in that stronger electrostatic attraction may be secured by charging two or more times.

The preprinting remover 1600′ removing the white toner W remaining on the surface of the preprinting photosensitive drum 1300′, after the white toner W is settled on the surface of the metal material 100, may be included. Since a specific function and structure of the preprinting remover 1600′ are not different from the preprinting remover 1600 previously described with reference to FIGS. 2 and 7, the above-described contents may be replaced.

A remover for removing toner may also be provided on the preprinting transfer belt 1800′. For example, after settling a toner for image formation on the metal material 100, a blade 1810′ for removing the toner remaining on a surface of the preprinting transfer belt 1800′, and a collection bin 1820′ for collecting the separated toner on a lower end of the blade 1810′ to fall the separated toner on the metal material 100 to prevent a decrease in printing quality, may be included. A configuration for removing the toner remaining on the preprinting transfer belt 1800′ may not be different from a main printing transfer belt 2800′ described later.

After the white toner W is settled on the metal material 100, the preprinting fixer 1700′ for stably forming an image by fixing the white toner W on the metal material 100 may be provided on a rear end of the preprinting photosensitive drum 1300′ and a rear end of the preprinting transfer belt 1800′ based on a traveling direction of the metal material 100. Since a specific function and structure preprinting fixation unit 1700′ are not different from the preprinting fixation unit 1700 previously described with reference to FIG. 2, the above-described contents may be replaced.

Next, the main printing equipment (2000 and 2000′) will be described in detail.

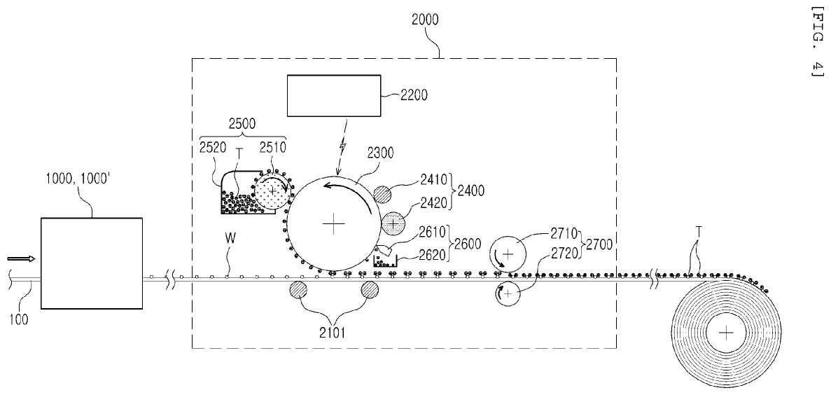

FIG. 4 illustrates an example of the main printing equipment 2000. The main printing equipment 2000 illustrated in FIG. 4 may include a main printing photosensitive drum 2300, a main printing photosensitive drum charging unit 2410, a main printing photosensitive drum discharging unit 2420, a main printing exposure unit 2200, a main printing developer 2500, a main printing metal material charging unit 2101, a main printing remover 2600, a main printing fixer 2700, or the like.

The main printing photosensitive drum 2300 may transfer and settle a toner T attached to a surface of the main printing photosensitive drum 2300, to and on a surface of the metal material 100, while closely contacting the preprinted surface of the metal material 100 to rotate in one direction, to transfer an image. Although the main printing photosensitive drum 2300 is illustrated in FIG. 4 as rotating in one direction, the main printing photosensitive drum 2300 does not necessarily rotate in only one direction, and may also rotate in both directions. The main printing photosensitive drum 2300 may be sufficient as long as it is commonly used in the technical field to which the present disclosure pertains, and a type thereof is not particularly limited. As a preferred example thereof, an organic photo conductor (OPC) drum may be used.

The main printing developer 2500 may be provided on one side of the main printing photosensitive drum 2300, and may provide the toner T for forming an image on a surface thereof. The main printing developer 2500 may be sufficient as long as it provides the toner to the main printing photosensitive drum 2300, and a form or shape thereof is not particularly limited. In FIG. 4, as a preferred example, the main printing developer 2500 may include a toner container 2520 containing the toner T, and a developing roller 2510 transferring the toner from the toner container 2520 to the main printing photosensitive drum 2300. The developing roller 2520 may not be essential, and in some cases, the toner T may be provided directly from the toner container 2520 to the photosensitive drum 2300. The toner T may form an image on the surface of the metal material, and any toner known to a person skilled in the art in the field to which the present disclosure pertains may be used, and a type thereof is not particularly limited. For example, a material having a polymer structure may be used. In addition, in the present disclosure, materials that may provide various s functions (e.g., a fluorescent material, a magnetic material, an electrically conductive material, or the like) may be added to the toner, and not only an image having a function be implemented, but particles of the toner may also be used to provide various functions, to give roughness or realize a three-dimensional shape.

The main printing photosensitive drum charging unit 2410 for charging a surface of the main printing photosensitive drum 2300, before the toner T is provided, may be included. The main printing photosensitive drum charging unit 2410 may apply an electrostatic charge to the surface of the photosensitive drum. As the charging unit, a corona wire may be usually used.

The main printing exposure unit 2200 applying light energy to the charged surface of the main printing photosensitive drum 2300 according to a required image, between the main printing developer 2500 and the main printing photosensitive drum charging unit 2410, may be provided. A position of the main printing exposure unit 2200 may not be important, but the light energy may be imparted to a surface of the main printing photosensitive drum 2300 between the main printing developer 2500 and the main printing photosensitive drum charging unit 2410. Due to the light energy, some charges may be removed from the surface of the main printing photosensitive drum 2300, and toner may be attached to the surface of the main printing photosensitive drum 2300 by the main printing developer 2500. The light energy is preferably provided by a laser or a light emitting diode (LED). In using the light energy, a specific structure and function of the main printing exposure unit 2200 may not be different from those of the preprinting exposure unit 1200 of FIG. 6 described above.

The main printing metal material charging unit 2101 charging the surface of the metal material 100 to move and settle the toner T attached to the surface of the main printing photosensitive drum 2300, to the surface of the metal material 100, may be included. Since a structure and function of the main printing metal material charging unit 2101 may not be different from those of the preprinting metal material charging unit (1101 and 1101′) described above, detailed information will be omitted.

The main printing remover 2600 removing the toner T remaining on the surface of the main printing photosensitive drum 2300, after the toner T is settled on the surface of the metal material 100, may be included. The main printing remover 2600 may include a blade 2610 separating the portion of the toner remaining on the surface of the main printing photosensitive drum 2300, and a collection bin 2620 collecting the separated toner in a lower end of the blade 2610, to prevent the separated toner from falling onto the metal material 100 to deteriorate printing quality. An alcohol brush may be further included, and since the alcohol brush may not be different from the previous description of the preprinting remover 1600 and the contents of FIG. 7, detailed description thereof will be omitted.

After the toner T is settled on the metal material 100, the main printing fixation unit 2700 for stably forming an image by fixing the toner T on the metal material 100 may be provided on a rear end of the main printing photosensitive drum 2300 based on a traveling direction of the metal material 100. The main printing fixation unit 2700 may include a fused roll 2710 applying heat to the toner T to fix the toner T settled on the metal material 100, and a pressure roll 2720 applying pressure to assist fixation of the toner T. In this case, a heating temperature of the fused roll 2710 may be 25 to 400° C.

It is more preferable that the main printed metal material charging unit 2101 and the pressure roll 2720 have a structure capable of moving in upward and downward directions. The metal material 100 may not always have a constant thickness, and may be a very thin film or a thick plate. Therefore, when the main printing metal material charging unit 2101 and the pressure roll 2720 have a variable structure and move in upward and downward directions, depending on a thickness of the metal material 100, the image may be printed regardless of the thickness of the metal material 100.

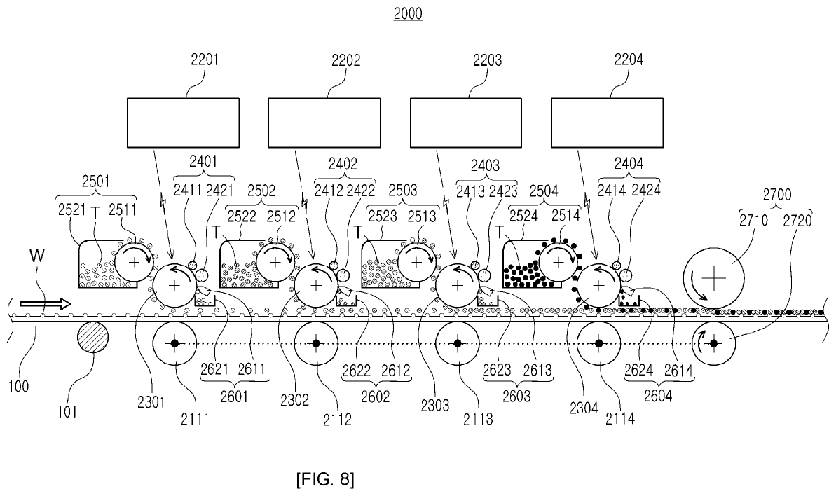

At least one toner may be used to print various images, and in this case, the main printing photosensitive drum, the main printing photosensitive drum charging unit, the main printing photosensitive drum discharging unit, the main printing exposure unit, the main printing developer, and the main printing remover may be provided in pairs and two or more in a travelling direction of the metal material. FIG. 8 schematically illustrates another embodiment of the main printing equipment. FIG. 8 illustrates main printing equipment for transferring images by providing four types of toner to print a color image. Colors of the four types of toner T may be cyan (C), yellow (Y), magenta (M), or black (K). The four types of toner do not necessarily have to be used, and may include white (W). It is possible to use some or more of these in duplicate, and the order may not be also set. A person skilled in the art may arbitrarily select one considering a required image, work efficiency, or the like.

FIG. 8 illustrates main printing equipment when using four types of toner. Therefore, in FIG. 8, to settle the four types of toners on a metal material 100, four pairs of main printing photosensitive drum (2301, 2302, 2303, and 2304), main printing photosensitive drum charging and discharging unit (2401, 2402, 2403, and 2404), main printing exposure unit (2201, 2202, 2203, and 2204), main printing developer (2501, 2502, 2503, and 2504), and main printing remover (2601, 2602, 2603, and 2604) may be provided. A main printing fixation unit 2700 for fixing the toner settled on the metal material 100 may be for finally settling an image, and there does not necessarily need to be multiple.

As illustrated in FIG. 8, when using multiple photosensitive drums, since there may be a risk of sagging due to characteristics of the metal material 100 continuous methods such as a roll-to-roll process or the like, a plurality of support rolls 2111, 2112, 2113, and 2114 for continuous movement while supporting the metal material may be provided. It is preferable that the support rolls 2111, 2112, 2113, and 2114 also have a variable structure and move in upward and downward directions, depending on a thickness of the metal material 100.

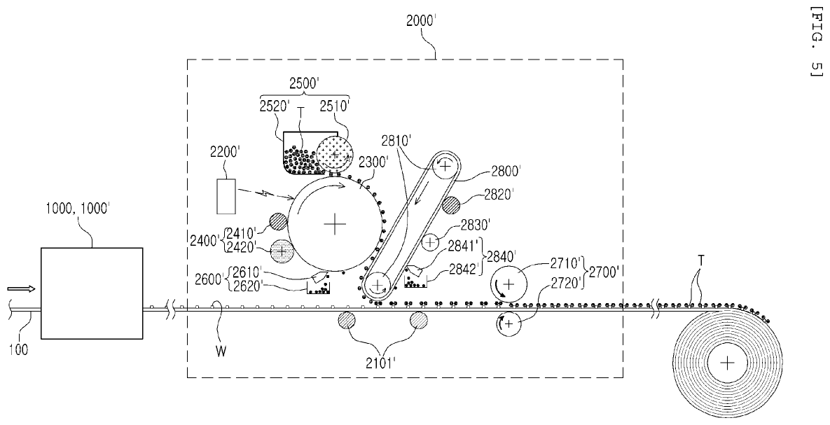

FIG. 5 illustrates another example of the main printing equipment 2000′. The main printing equipment 2000′ illustrated in FIG. 5 may include a main printing transfer belt 2800′, a main printing photosensitive drum 2300′, a main printing photosensitive drum charging and discharging unit 2400′, a main printing exposure unit 2200′, a main printing developer 2500′, a main printing remover 2600′, a main printing fixation unit 2700′, or the like

The main printing transfer belt 2800′ may transfer and settle a toner T attached to a surface of the main printing transfer belt 2800′, to and on a surface of a metal material 100, while closely contacting a surface of the metal material 100 in which a white image is preprinted, to rotate in one direction, and, at the same time, may play a role in protecting a surface of the main printing photosensitive drum 2300′ and improving quality of an image. When hardness of the metal material 100 is high, the surface of the main printing photosensitive drum 2300′ may be damaged due to contact between the metal material 100 and the main printing photosensitive drum 2300′. In this case, repair and replacement costs for the main printing photosensitive drum 2300′ may increase, and accuracy of the transferred image may also deteriorate, to deteriorate printing quality. A method in which the toner does not move from the main printing photosensitive drum 2300′ to the metal material 100, but transferred via the main printing transfer belt 2800′, may be adopted.

A driving roll 2810′ of the main printing transfer belt may be provided to drive the main printing transfer belt 2800′ in a traveling direction, a charger 1820′ of the preprinting transfer belt may be provided to charge a surface of the main printing transfer belt 2800′ before receiving the toner T from the main printing photosensitive drum 2300′, and a corona wire may be usually frequently used. After the toner T of the main printing transfer belt 2800′ is transferred to the metal material 100 to transfer the image, a toner remover 2840′ for removing the toner T remaining on the transfer belt may be provided, and a discharging unit 2830′ of the preprinting transfer belt for discharging an charge of the transfer belt, after the toner T is removed, may be provided.

The main printing photosensitive drum 2300′ may transfer the toner T attached to a surface of the main printing photosensitive drum 2300′, to the surface of the main printing transfer belt 2800′, while contacting the transfer belt to rotate in an opposite direction. The main printing photosensitive drum 2300′ may not be different from the preprinting photosensitive drum 1300′ described above.

The main printing developer 2500′ may be provided on one side of the main printing photosensitive drum 2300′, and may provide the toner T for forming an image on a surface thereof. The technical content and configuration of the main printing developer 2500′ may be substantially identical to the preprinting developer and the main printing developer of FIGS. 2, 3, and 4, and the detailed description thereof may be replaced with the above-described contents.

A main printing photosensitive drum charging unit 2410′ for charging the surface of the main printing photosensitive drum 2300′, before the toner T is provided, and a main printing photosensitive drum discharging unit 2420′ for discharging the charged main printing photosensitive drum may be substantially the same in technical content and configuration as the photosensitive drum charging unit and photosensitive drum discharging unit described in the preprinting equipment and the main printing equipment of FIGS. 2, 3, and 4, and the detailed description thereof may be replaced with the contents described above.

The main printing exposure unit 2200′ applying light energy to the charged surface of the main printing photosensitive drum 2300′ according to a required image, between the main printing developer 2500′ and the main printing photosensitive drum charging unit 2410′ may be provided. A position of the main printing exposure unit 2200′ may not be important, but the light energy may be imparted to a surface of the main printing photosensitive drum 2300′ between the main printing developer 2500′ and the main printing photosensitive drum charging unit 2410′. Since a specific function and structure of the preprinting exposure unit 2200′ may not be different from the preprinting exposure unit 1200 previously described with reference to FIGS. 2 and 6, the above-described contents may be replaced.

The main printed metal material charging unit 2101′ charging the surface of the metal material 100 such that the image forming toner T transferred from the main printing photosensitive drum 2300′ moves and settles on the metal material 100 on which the white image is preprinted. Since the main printed metal material charging unit 2101′ has no difference in structure and technical content from the metal material charging unit of FIGS. 2, 3, and 4 described above, the above-described contents may be replaced.

The main printing photosensitive drum 2300′ may include a main printing remover 2600′ for removing the toner remaining on a surface of the main printing photosensitive drum 2300′, after the toner on the surface is provided to the main printing transfer belt 2800′. Since a specific function and structure of the preprinting remover 2600′ may not be different from the preprinting remover 1600 previously described with reference to FIGS. 2 and 7, the above-described contents may be replaced.

A remover for removing the toner may also be provided on the main printing transfer belt 1800′. For example, a blade 2810′ removing the toner remaining on the surface of the main printing transfer belt 2800′, after a toner for image formation is settled on the metal material 100, and a collection bin 1820′ collecting the separated toner in a lower end of the blade 2810′, to prevent the separated toner from falling onto the metal material 100 to deteriorate printing quality. A configuration for removing the toner remaining on the main printing transfer belt 2800′ may not be different from that of the preprinting transfer belt 1800′ described above.

After the toner T is settled on the metal material 100, the main printing fixation unit 2700′ for stably forming an image by fixing the toner T on the metal material 100 may be provided on a rear end of the main printing photosensitive drum 2300′ based on a traveling direction of the metal material 100. Since a specific function and structure of this preprinting fixation unit 2700′ may be different from the preprinting fixation unit (1700 and 1700′) and the main printing fixation unit 2700 previously described with reference to FIGS. 2, 3, and 4, the above-mentioned contents may be replaced.

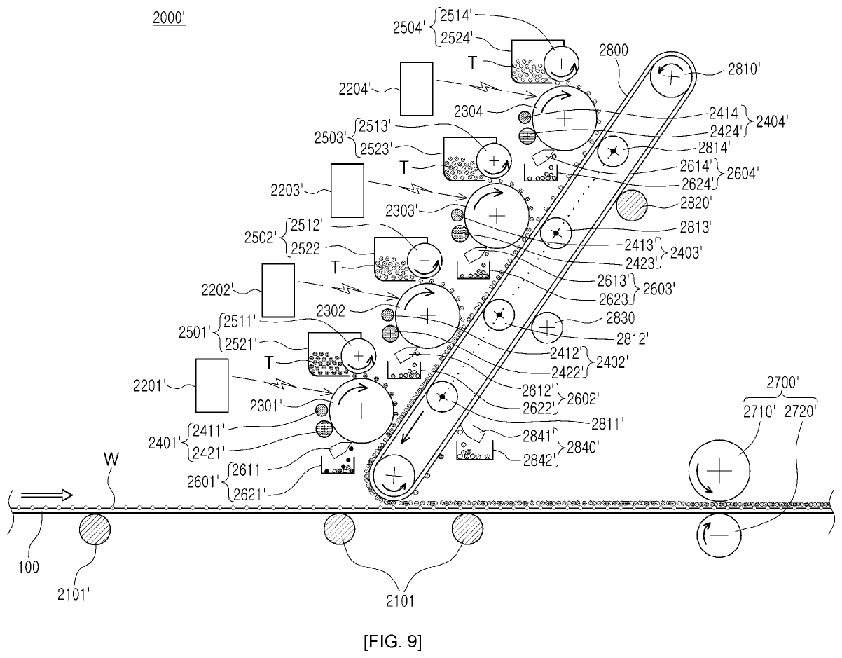

At least one toner may be used to print various images, and in this case, the main printing photosensitive drum, the main printing photosensitive drum charging unit, the main printing photosensitive drum discharging unit, the main printing exposure unit, the main printing developer, and the main printing remover may be provided in pairs and two or more in a travelling direction of the transfer belt. FIG. 9 schematically illustrates another embodiment of the main printing equipment. FIG. 9 illustrates printing equipment for transferring images by providing four types of toner to print a color image. Colors of the four types of toner T may be cyan (C), yellow (Y), magenta (M), or black (K). The four types of toner do not necessarily have to be used, and may include white (W). It is possible to use some or more of these in duplicate, and the order may not be also set. A person skilled in the art may arbitrarily select one considering a required image, work efficiency, or the like.

FIG. 9 illustrates printing equipment when using four types of toner. Therefore, in FIG. 9, to settle the four types of toners on a metal material 100 on which a white image is preprinted, four pairs of main printing photosensitive drums (2301′, 2302′, 2303′, and 2304′), main printing photosensitive drum charging and discharging unit (2401′, 2402′, 2403′, and 2404′), main printing exposure unit (2201′, 2202′, 2203′, and 2204′), main printing developer (2501′, 2502′, 2503′, and 2504′) and main printing remover (2601′, 2602′, 2603′, and 2604′) may be located in a traveling direction of a transfer belt 2800′. Therefore, as illustrated in FIG. 9, the toner T transferred by each pair may be transferred to a main printing transfer belt 2800′, and the main printing transfer belt 2800′ may settle the same back to the metal material 100. In addition, in this case, the main printing fixation unit 2700′ for fixing the toner settled on the metal material 100 may be for settling a final transferred image, and does not necessarily need to be multiple.

As illustrated in FIG. 9, when a plurality of photosensitive drums are used, a length of the main printing transfer belt 2800′ may increase, and there may be a risk of sagging due to this, support rolls 2811′, 2812′, 2813′, and 2814′ of the transfer belt promoting continuous movement while supporting the main printing transfer belt 2800′ may be further provided.

When printing on both surfaces of the metal material 100, at least one of the preprinting equipment (1000 and 1000′) and at least one of the main printing equipment (2000 and 2000′) may be arranged on and below the metal material 100.

Next, a printing method of the present disclosure will be described in detail. The printing method of the present disclosure may include a preprinting operation of printing a white image on a surface of a metal material 100, which is continuously moving; and a main printing operation of printing an image on a surface of the metal material 100 on which the white image is printed.

An embodiment of a preprinting method for printing the white image will be described with reference to FIG. 2, which may include a preprinting charging operation of charging a surface of a preprinting photosensitive drum 1300 rotating in one direction; a preprinting exposure operation of applying light energy according to a required white image to the charged surface of the preprinting photosensitive drum 1300; a preprinting development operation of providing a white toner W to the surface of the preprinting photosensitive drum 1300 after the exposure; a preprinting transfer operation of moving and settling the white toner W attached to the surface of the preprinting photosensitive drum 1300 to the charged surface of the metal material 100; a preprinting fixation operation of fixing the white toner W settled on the surface of the metal material 100; a preprinting removal operation of removing the white toner W remaining on the surface of the preprinting photosensitive drum 300 after the transfer; and a preprinting discharge operation of discharging the surface of the preprinting photosensitive drum 300.

Specifically, first, a surface of a preprinting photosensitive drum 1300 rotating in one direction may be charged (preprinting charged). The preprinting photosensitive drum 1300 may be prepared to form a charge layer charged with a certain charge, and may then apply a white image using a white toner W. The surface of the preprinting photosensitive drum 1300 may have a positive (+) charge or a negative (−) charge.

Exposure (preprinting exposure) may be performed to apply light energy to the surface of the preprinting photosensitive drum 1300 that may be charged by forming the charge layer. The exposure may remove a charge from the surface of the preprinting photosensitive drum 1300 using the light energy, to move the toner on the surface of the preprinting photosensitive drum 1300 according to a required white image. The light energy may be in various forms, and is preferably provided by a laser or LED light source.

The white toner W may be attached to an exposed surface of the preprinting photosensitive drum 1300, and this process may be called a development process (preprinting development). The white toner W may be charged with a charge opposite to an charged charge of the preprinting photosensitive drum 1300, and may be attached to the surface of the preprinting photosensitive drum 1300. In the development process, referring to an example of FIG. 2, a developing roller 1510 may transfer a certain amount of the white toner W from a toner container 1520 to the preprinting photosensitive drum 1300. The developing roller 1510 is not necessarily necessary, and may be moved directly from the toner container 1520 to the preprinting photosensitive drum 1300. For example, the preprinting development operation may be a process in which the toner is attached according to the required image on the surface of the preprinting photosensitive drum 300.

Thereafter, the toner attached to the surface of the preprinting photosensitive drum 1300 may move to the charged metal material 100, and transfer (preprinting transfer operation) of settling the white toner on the surface of the metal material 100 may be performed. The metal material 100 may be charged with the same charge as the preprinting photosensitive drum 1300, and may be charged with an opposite charge to the toner, such that the white toner W attached to the preprinting photosensitive drum 1300 may move to the metal material 100. The preprinting transfer operation may be a process in which an image is printed on the surface of the metal material 100, and in which the metal material 100 is charged with an opposite charge to the toner, to pull the toner to be settled on the surface of the metal material 100. Charging of the metal material 100 may be performed before, after, or both before and after the preprinting transfer operation. When a coating layer is separately formed on the surface of the metal material 100, a preprinting metal material charging unit may be provided to contact the coating layer such that the coating layer is charged to transfer the same onto the coating layer.

The white toner settled on the surface of the metal material 100 may go through an operation (preprinting fixation operation) of being fixed, and the fixing may be performed by a thermal compression process, and specifically, may be compressed at the same time as heat is applied by a fused roll 1710 and a pressure roll 1720. In this case, a heating temperature may be 25 to 400° C. As described above, the white toner W used in the present disclosure may be used for printing a metal material, and a main component thereof may have a polymer structure. In particular, because the metal material has a high heat transfer rate, it may be difficult to melt and adsorb the toner. Therefore, the metal material should be heated to an appropriate temperature such that the toner is adsorbed. For this purpose, since reaction of the toner occurs at a temperature above room temperature and the toner is fixed to the surface of the metal material, the heating temperature may be 25° C. or higher. When the temperature exceeds 400° C., a polymer structure of the toner may decompose. Therefore, the heating may not exceed 400° C. More preferably, it may be heated to 50 to 300° C.

Separately from the metal material 100, a removal operation (preprinting removal operation) may be performed to remove the toner remaining on the surface of the preprinting photosensitive drum 1300 after the transfer. This may leave an afterimage in a subsequent printing process due to the remaining portion of the toner, which may reduce printing quality. In this case, as illustrated in FIGS. 2 and 7, in the removal operation, physical removal may be performed by a blade 1610, and the toner removed in this manner may be recovered into a collection bin 1620 to prevent the same from falling onto the metal material. For more complete removal, chemical removal may be further performed using an alcohol brush 1630 after the physical removal.

Thereafter, to extinguish a charge remaining on the preprinting photosensitive drum 1300, an operation of discharging the surface of the preprinting photosensitive drum 1300 (preprinting discharge operation) may be performed. Through the discharge, the preprinting photosensitive drum 1300 may be prepared for new printing.

Another embodiment of a preprinting method for printing the white image will be described with reference to FIG. 3, which may include a preprinting charging operation of charging a surface of a preprinting photosensitive drum 1300′ rotating in one direction; a preprinting exposure operation of applying light energy according to a required white image to the charged surface of the preprinting photosensitive drum 1300′; a preprinting development operation of providing a white toner W to the surface of the preprinting photosensitive drum 1300′ after the exposure; an operation of moving the white toner W attached to the surface of the preprinting photosensitive drum 1300′, to an charged surface of a preprinting transfer belt 1800′; a preprinting transfer operation of moving and settling the toner attached to the surface of the preprinting transfer belt 1800′ to the charged surface of the metal material 100; a preprinting fixation operation of fixing the white toner W settled on the surface of the metal material 100; a preprinting removal operation of removing a portion of the white toner W remaining on the surface of the preprinting photosensitive drum 1300′ and the surface of the preprinting transfer belt 1800′ after the transfer; and a preprinting discharge operation of discharging the surface of the preprinting photosensitive drum 1300′ and the surface of the preprinting transfer belt 1800′.

Specifically, first, a surface of a preprinting photosensitive drum 1300′ rotating in one direction may be charged (preprinting charged). The surface of the preprinting photosensitive drum 1300′ rotating in one direction may be charged. Through this, a charge layer may be formed on the preprinting photosensitive drum 1300′ with a certain charge, and then preparation may be made to apply a white image using a white toner W. The surface of the preprinting photosensitive drum 1300′ may have a positive (+) charge or a negative (−) charge.

Exposure (preprinting exposure) may be performed to apply light energy to the surface of the preprinting photosensitive drum 1300′ that may be charged by forming the charge layer. The exposure may remove a charge from the surface of the preprinting photosensitive drum 1300′, to move the toner on the surface of the preprinting photosensitive drum 1300′ according to a required white image. The light energy may be in various forms, and is preferably provided by a laser or LED light source.

The white toner W may be attached to an exposed surface of the preprinting photosensitive drum 1300′, and this process may be called a development process (preprinting development operation). The white toner W may be charged with a charge opposite to an charged charge of the preprinting photosensitive drum 1300′, and may be attached to the surface of the preprinting photosensitive drum 1300′. In the development process, referring to an example of FIG. 3, a developing roller 1510′ may transfer a certain amount of the white toner W from a toner container 1520′ to the preprinting photosensitive drum 1300′. The developing roller 1510 is not necessarily necessary, and may be moved directly from the toner container 1520′ to the preprinting photosensitive drum 1300. For example, the preprinting development operation may be a process in which the toner is attached according to the required image on the surface of the preprinting photosensitive drum 1300′.

Thereafter, the white toner W attached to the surface of the preprinting photosensitive drum 1300′ may move to the charged preprinting transfer belt 1800′, to move the white toner W to the preprinting transfer belt 1800′. In this case, the surface of the preprinting transfer belt 1800′ may be charged with an opposite charge to the white toner W, to pull the toner to be moved to the surface of the preprinting transfer belt 1800′. The preprinting transfer belt 1800′ may be used to avoid direct contact of the preprinting photosensitive drum 1300′ with the metal material 100. In particular, to prevent damage to the surface of the photosensitive drum when using a metal material having high hardness, the white toner W on the surface of the preprinting photo drum 1300′ may first move to the preprinting transfer belt 1800′.

As described above, the white toner W attached to the surface of the preprinting transfer belt 1800′ may move to the charged metal material 100, and transfer (preprinting transfer operation) of settling the white toner on the surface of the metal material 100 may be performed. The metal material 100 may be charged with the same charge as the preprinting transfer belt 1800′, and may be charged with an opposite charge to the toner, such that the white toner W of the preprinting transfer belt may move to the metal material 100. The preprinting transfer operation may be a process in which an white image is printed on the surface of the metal material 100, and in which the metal material 100 is charged with an opposite charge to the white toner, to pull the white toner to be settled on the surface of the metal material 100. Charging of the metal material 100 may be performed before, after, or both before and after the preprinting transfer operation. When a coating layer is separately formed on the surface of the metal material 100, a preprinting metal material charging unit may be provided to contact the coating layer such that the coating layer is charged to transfer the same onto the coating layer.

The white toner settled on the surface of the metal material 100 may go through an operation (preprinting fixation operation) of being fixed, and the fixing may be performed by a thermal compression process, and specifically, may be compressed at the same time as heat is applied by a fused roll 1710′ and a pressure roll 1720′. In this case, a heating temperature may be 25 to 400° C. More preferably, it may be heated to 50 to 300° C. Since this temperature range may not be different from what was previously described, the previous contents may be replaced.

After the toner may be moved to the preprinting transfer belt 1800′, the preprinting removal operation may be performed to remove the toner remaining on the surface of the preprinting photosensitive drum 1300′ and the toner fixed to the metal material 100 and then remaining on the surface of the preprinting transfer belt 1800′. This may leave an afterimage in a subsequent printing process due to the remaining portion of the toner, which may reduce printing quality. In this case, as illustrated in FIGS. 3 and 7, in the removal operation, physical removal may be performed by a blade (1610 and 1610′), and the toner removed in this manner may be recovered into a collection bin (1620 and 1620′) to prevent the same from falling onto the metal material. For more complete removal, chemical removal may be further performed using an alcohol brush 1630 after the physical removal. Although not illustrated in the present disclosure, in some cases, the transfer belt may further include the alcohol brush.

Thereafter, to extinguish a charge remaining on the preprinting photosensitive drum 1300′ and the preprinting transfer belt 1800′, an operation of discharging the surfaces of the preprinting photosensitive drum 1300′ and the preprinting transfer belt 1800′ may be performed. Through the discharge, the preprinting photosensitive drum 1300′ may be prepared for new printing again.

The present disclosure may have advantages that image correction is easier by including the preprinting operation. When using a conventional inkjet, and an image error occurs, the inkjet should be discarded, but the present disclosure may have advantages of enabling correction and rework by transporting a metal material in a reverse direction, and creating a white image again. In addition, retransfer is possible even when the metal material is transferred in the reverse direction or is discontinuous.

Next, a main printing operation of printing an image (main printing image) on a surface of the metal material 100 on which the white image is printed will be described. Referring to FIG. 4, an example implementation of the main printing operation may be as follows.

An embodiment of the main printing operation may include a main printing charging operation of charging a surface of a main printing photosensitive drum 2300 rotating in one direction; a main printing exposure operation of applying light energy according to a required image to the charged surface of the main printing photosensitive drum 2300; a main printing development operation of providing a toner T to the surface of the main printing photosensitive drum 2300 after the exposure; a main printing transfer operation of moving and settling the toner T attached to the surface of the main printing photosensitive drum 2300 to the charged surface of the metal material 100; a main printing fixation operation of fixing the toner T settled on the surface of the metal material 100; a main printing removal operation of removing a portion of the toner T remaining on the surface of the main printing photosensitive drum 2300 after the transfer; and a main printing discharge operation of discharging the surface of the main printing photosensitive drum 2300.

In the main printing operation, the main printing charging operation, the main printing exposure operation, the main printing development operation, the main printing transfer operation, the main printing fixation operation, the main printing removal operation, and the main printing discharge operation may not be different from the preprinting operation previously described with reference to FIG. 2 in view of the technical operation and contents, except that a white toner W is replaced with a toner T for the main printing image. Therefore, the description of each operation may be replaced with the description of the preprinting operation described with reference to FIG. 2.

In the main printing operation, toners of various colors such as two or more colors, for example, white (W), cyan (C), yellow (Y), magenta (M), black (K), or the like may be used to print color images. In this case, the printing may be done using two or more toners, and in this case, as described above, the main printing photosensitive drum, the main printing photosensitive drum charging unit, the main printing photosensitive drum discharging unit, the main printing exposure unit, the main printing developer, and the main printing remover may be provided in pairs and two or more, and various colors may be realized as at least twice of the main printing charging operation, the main printing exposure operation, the main printing development operation, the main printing transfer operation, and the main printing removal operation are performed. An example thereof is illustrated in FIG. 8. In FIG. 8, four pairs of main printing photosensitive drum, main printing photosensitive drum charging unit, main printing photosensitive drum discharging unit, main printing exposure unit, main printing developer, and main printing remover may be provided, and each of the operations may be performed to perform the main printing operation. Order of the colors is not particularly limited in the present disclosure, and may be determined considering a required image, work efficiency, or the like.

Another embodiment of a main printing operation of printing an image (main printing image) on a surface of the metal material 100 on which the white image is printed will be described with reference to FIG. 5 as follows.

Another embodiment of the main printing operation may include a main printing charging operation of charging a surface of a main printing photosensitive drum 2300′ rotating in one direction; a main printing exposure operation of applying light energy according to a required image to the charged surface of the main printing photosensitive drum 2300′; a main printing development operation of providing a toner T to the surface of the main printing photosensitive drum 2300′ after the exposure; an operation of moving the toner attached to the surface of the main printing photosensitive drum 2300′, to an charged surface of a main printing transfer belt 2800′; a main printing transfer operation of moving and settling the toner attached to the surface of the main printing transfer belt 2800′ to the charged surface of the metal material 100; a main printing fixation operation of fixing the toner settled on the surface of the metal material 100; a main printing removal operation of removing a portion of the toner remaining on the surface of the main printing photosensitive drum 2300′ and the surface of the main printing transfer belt 2800′ after the transfer; and a main printing discharge operation of discharging the surface of the main printing photosensitive drum 2300′ and the surface of the main printing transfer belt 2800′.

In the main printing operation using the transfer belt, the main printing charging operation, the main printing exposure operation, the main printing development operation, the operation of moving the toner to the main printing transfer belt, the main printing transfer operation, the main printing fixation operation, the main printing removal operation, and the main printing discharge operation may not be different from the preprinting operation using the transfer belt, previously described with reference to FIG. 3, in view of the technical operation and contents, except that a white toner W is replaced with a toner T for the main printing image. Therefore, the description of each operation may be replaced with the description of the preprinting operation described with reference to FIG. 3.

In the main printing operation using the transfer belt 2800′, toners of various colors such as two or more colors, for example, white (W), cyan (C), yellow (Y), magenta (M), black (K), or the like may be used to print color images. In this case, the printing may be done using two or more toners, and in this case, as described above, the main printing photosensitive drum, the main printing photosensitive drum charging unit, the main printing photosensitive drum discharging unit, the main printing exposure unit, the main printing developer, and the main printing remover may be provided in pairs and two or more, and various colors may be realized as at least twice of the main printing charging operation, the main printing exposure operation, the main printing development operation, the main printing transfer operation, and the main printing removal operation are performed. An example thereof is illustrated in FIG. 9. In FIG. 9, four pairs of main printing photosensitive drum, main printing photosensitive drum charging unit, main printing photosensitive drum discharging unit, main printing exposure unit, main printing developer, and main printing remover may be provided, and each of the operations may be performed to perform the main printing operation. Order of the colors is not particularly limited in the present disclosure, and may be determined considering a required image, work efficiency, or the like.

To print an image on both surfaces of the metal material, the preprinting operation and the main printing operation of the present disclosure described above may be applied sequentially or simultaneously to upper and lower surfaces to print the image on the both surfaces of the metal material.

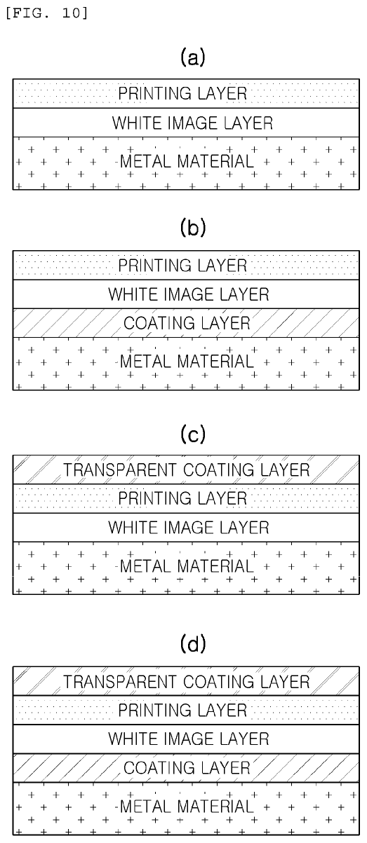

Next, a metal material manufactured using the above-described printing equipment or printing method will be described in detail. FIG. 10 schematically illustrates a printed metal material of the present disclosure, and the present disclosure will be described in detail below with reference to FIG. 10.

A printed metal material of the present disclosure may include a white image layer formed on a metal material, and a printing layer formed on the white image layer, as illustrated in portion (a) of FIG. 10. As described above, the metal material may be a steel sheet, a non-ferrous metal, a metal alloy, or the like, and a type thereof is not particularly limited.

The white image layer may be formed using the above-described preprinting equipment (1000 and 1000′) or by the above-described preprinting operation. Due to the presence of the white image layer, the subsequently formed printing layer (image printing layer formed by main printing) may secure better printing quality.

The printing layer may be formed using the above-described main printing equipment (2000 and 2000′) or by the above-described main printing operation. The printing layer may form more diverse images, as compared to an image formed on an existing metal material.

The printing layer has advantages of not only having a clear shape and color, but also having excellent processing characteristics due to high resistance to peeling, as compared to images formed by an existing printing method.

An existing printing method on a metal material was mainly performed by roll coating or inkjet coating using a liquid pigment or dye. This liquid type method uses transparent polymer resins (approximately 70 to 80 wt %) mixed with colored particles (approximately 20 to 30 wt %). In other words, since most of the pigments and dyes are transparent polymer resins, a shape or color may not be clearly visible, and when the liquid particles are large, possibility of peeling due to stress entirely applied to the polymer may increase to decrease processing characteristics.

In contrast, since a printing method using a laser, an LED, or the like of the present disclosure is adopted and a toner, which is a solid powder, is used, and each powder particle corresponds to a unit particle containing color, excellent color may be formed. Additionally, since an existing printing method uses a liquid pigment or dye, it may be greatly affected by a surface condition of a material to be printed. For example, since printing quality may be affected by surface roughness or surface shape of the material, effort may be required for pre-treatment of the surface, such as roughness management or the like. However, since a printing method according to the present disclosure may be a method in which toner powders are printed by an electrical adsorption process and a compression process, an image may be formed on a metal material more easily than the existing method.

In addition, a printed metal material of the present disclosure may have advantages of increased adhesion of a printing layer, as compared to those printing using an existing white ink. In other words, when a white liquid ink is used, there may be advantages in that white ink particles containing polymers may be large and peeling of an image layer may increase during curved processing or cutting, whereas a white image layer of the present disclosure may reduce peeling off the printing layer even under stress due to dispersion of the powder particles.

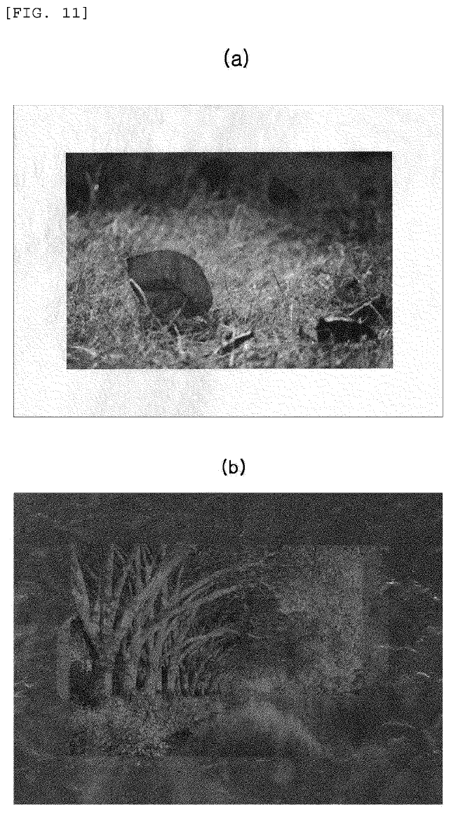

FIG. 11 illustrates a printed metal material manufactured by printing an image on a copper foil using a laser printing process. In portion (a) of FIG. 11, as in the present disclosure, a white image layer is preprinted, and a desired image is printed on the white image layer, and portion (b) of FIG. 11 illustrates a desired image printed on copper's unique color. As can be seen from portions (a) and (b) of FIG. 11, portion (a) has a clearer image, when the white image layer is present, to ensure excellent printing quality, as compared to portion (b).

A printed metal material of the present disclosure may further include a coating layer between the metal material and the white image layer, as illustrated in portion (b) of FIG. 10. The coating layer may include a wet or dry plating layer, such as an electrogalvanized (EG) layer, a hot dip galvanized (GI) layer, or the like.

In addition, the coating layer may include a pretreatment layer formed on the plating layer, an intermediate coating layer formed on the pretreatment layer, and an upper coating layer formed on the intermediate coating layer.

The pretreatment layer, the intermediate coating layer, and the upper coating layer are not particularly limited in the present disclosure, and may include all those known in the technical field to which the present disclosure pertains. Hereinafter, a preferred example will be described.

The pretreatment layer may be intended to improve adhesion between base metal and the intermediate coating layer (primer layer), may be usually formed within 1 μm, and may be coated by performing chromium-free polymer coating, chromium hexavalent (Cr⁶⁺) coating, or chromium trivalent (Cr³⁺) coating.

The intermediate coating layer (primer layer) may be for ensuring corrosion resistance and concealing an underlying layer, and may be formed to be about 5 μm, and may be coated using polyester, urethane, epoxy, or the like. The intermediate coating layer may be omitted depending on a purpose thereof.

The upper coating layer (top coating layer) may represent surface properties, and may be directly related to properties of a product, and the white image layer may be formed on the upper coating layer. Therefore, the upper coating layer may be intended for protection, color, concealment, or the like, when the surface may be physically hit, and for this purpose, may have a thickness of 15 to 20 μm, and polyester, urethane, epoxy, or the like may be used.

The printed metal material of the present disclosure may further include a transparent coating layer on the printing layer, as illustrated in portions (c) and (d) of FIG. 10. The transparent coating layer may serve to require gloss or protect the printing layer. The transparent coating layer is also not particularly limited in the present disclosure, and may include all those known in the technical field to which the present disclosure pertains.

For example, the transparent coating layer may be generally polymer-based, and in a similar manner to the upper coating layer, polymer resins such as polyester, urethane, or the like may be used, and in outdoor use, a fluorine resin may be used. The transparent coating layer may be formed to have a thickness of about 1 to 5 μm, depending on a purpose thereof.

### DESCRIPTION OF REFERENCE CHARACTERS

100 . . . METAL MATERIAL
1000, 1000′ . . . PREPRINTING EQUIPMENT
2000, 2000′ . . . MAIN PRINTING EQUIPMENT
1101, 1101′ . . . PREPRINTING METAL MATERIAL CHARGING UNIT
2101, 2101′ . . . MAIN PRINTING METAL MATERIAL CHARGING UNIT
1200, 1200′ . . . PREPRINTING EXPOSURE UNIT
2200, 2200′, 2201, 2201′, 2202, 2202′, 2203, 2203′, 2204, 2204′ . . . MAIN PRINTING EXPOSURE UNIT
1210 . . . LASER GENERATOR
1220 . . . SCANNING MIRROR
1300, 1300′ . . . PREPRINTING PHOTOSENSITIVE DRUM
2300, 2300′, 2301, 2301′, 2302, 2302′, 2303, 2303′, 2304, 2304′ . . . MAIN PRINTING PHOTOSENSITIVE DRUM
1400, 1400′ . . . PREPRINTING PHOTOSENSITIVE DRUM CHARGING AND DISCHARGING UNIT
2400, 2400′, 2401, 2401′, 2402, 2402′, 2403, 2403′, 2404, 2404′ . . . MAIN PRINTING PHOTOSENSITIVE DRUM CHARGING AND DISCHARGING UNIT
1410, 1410′ . . . PREPRINTING PHOTOSENSITIVE DRUM CHARGING UNIT
2410, 2410′, 2411, 2411′, 2412, 2412′, 2413, 2413′, 2414, 2414′ . . . MAIN PRINTING PHOTOSENSITIVE DRUM CHARGING UNIT
1420, 1420′ . . . PREPRINTING PHOTOSENSITIVE DRUM DISCHARGING UNIT
2420, 2420′, 2421, 2421′, 2422, 2422′, 2423, 2423′, 2424, 2424′ . . . MAIN PRINTING PHOTOSENSITIVE DRUM CHARGING UNIT
1500, 1500′ . . . PREPRINTING DEVELOPER
2500, 2500′, 2501, 2501′, 2502, 2502′, 2503, 2503′, 2504, 2504′ . . . MAIN PRINTING DEVELOPER
1510, 1510′, 2510, 2510′ 2511, 2511′, 2512, 2512′, 2513, 2513′, 2514, 2514′ . . . DEVELOPING ROLLER
1520, 1520′, 2520, 2520′ 2521, 2521′, 2522, 2522′, 2523, 2523′, 2524, 2524′ . . . TONER CONTAINER
1600, 1600′ . . . PREPRINTING REMOVER
2600, 2600′, 2601, 2601′, 2602, 2602′, 2603, 2603′, 2604, 2604′ . . . MAIN PRINTING REMOVER
1610, 1610′, 2610, 2610′ 2611, 2611′, 2612, 2612′, 2613, 2613′, 2614, 2614′ . . . BLADE
1620, 1620′, 2620, 2620′ 2621, 2621′, 2622, 2622′, 2623, 2623′, 2624, 2624′ . . . COLLECTION BIN
1630 . . . ALCOHOL BRUSH
1700, 1700′ . . . PREPRINTING FIXATION UNIT
2700, 2700′ . . . MAIN PRINTING FIXATION UNIT
1710, 1710′, 2710, 2710′ . . . FUSED ROLL
1720, 1720′, 2720, 2720′ . . . PRESSURE ROLL
1800′ PREPRINTING TRANSFER BELT, 2800′ . . . MAIN PRINTING TRANSFER BELT
1810′, 2810′ . . . TRANSFER BELT DRIVING ROLL
1811′, 1812′, 1813′, 1814′, 2811′, 2812′, 2813′, 2814′ . . . TRANSFER BELT SUPPORT ROLL
1820′, 2820′ . . . TRANSFER BELT CHARGING UNIT
1830′, 2830′ . . . TRANSFER BELT DISCHARGING UNIT
1840′, 2840′ . . . TRANSFER BELT TONER REMOVER
1841′, 2841′ . . . TRANSFER BELT BLADE
1842′, 2842′ . . . TRANSFER BELT COLLECTION BIN

1. Printing equipment having excellent printing quality, comprising:
preprinting equipment (1000 and 1000′) printing a white image on a surface of a metal material 100, which is continuously moving; and
main printing equipment (2000 and 2000′) printing an image on a surface of the metal material 100 on which the white image is printed.

2. The printing equipment of claim 1, wherein the preprinting equipment 1000 comprises:
a preprinting photosensitive drum 1300 transferring and settling a white toner W attached to a surface of the preprinting photosensitive drum 1300, to and on the surface of the metal material 100, while closely contacting the metal material 100 to rotate in one direction;
a preprinting developer 1500 provided on one side of the preprinting photosensitive drum 1300 and providing the white toner W to the surface of the preprinting photosensitive drum 1300;
a preprinting photosensitive drum charging unit 1410 charging the surface of the preprinting photosensitive drum 1300, before the white toner W is provided;
a preprinting exposure unit 1200 applying light energy to the surface of the preprinting photosensitive drum 300 according to a required image, between the preprinting developer 1500 and the preprinting photosensitive drum charging unit 1410;
a preprinting metal material charging unit 101 charging the surface of the metal material 100 to transfer the white toner W attached to the surface of the preprinting photosensitive drum 1300, to the surface of the metal material 100;
a preprinting remover 1600 removing the white toner W remaining on the surface of the preprinting photosensitive drum 1300, after the white toner W is settled on the surface of the metal material 100;
a preprinting photosensitive drum discharging unit 1420 removing an charge from the preprinting photosensitive drum 1300, after the white toner W is removed; and
a preprinting fixer 1700 located on a rear end of the preprinting photosensitive drum 1300, to fix the white toner W settled on the surface of the metal material 100.

3. The printing equipment of claim 1, wherein the preprinting equipment 1000′ comprises:
a preprinting transfer belt 1800′ transferring and settling a white toner W attached to a surface of the preprinting transfer belt 1800′, to and on the surface of the metal material 100, while closely contacting the metal material 100 to rotate in one direction;
a preprinting photosensitive drum 1300′ transferring the white toner W attached to a surface of the preprinting photosensitive drum 1300′, to the surface of the preprinting transfer belt 1800′, while contacting closely the preprinting transfer belt 1800′ to rotate in an opposite direction;
a preprinting developer 1500′ provided on one side of the preprinting photosensitive drum 1300′ and providing the white toner W to the surface of the preprinting photosensitive drum 1300′;
a preprinting photosensitive drum charging unit 1410′ charging the surface of the preprinting photosensitive drum 1300′, before the white toner W is provided;
a preprinting exposure unit 1200′ applying light energy to the surface of the preprinting photosensitive drum 1300′ according to a required image, between the preprinting developer 1500′ and the preprinting photosensitive drum charging unit 1410′;
a preprinting metal material charging unit 1101′ charging the surface of the metal material 100 to transfer the white toner W attached to the surface of the preprinting transfer belt 1800′, to the surface of the metal material 100;
a preprinting remover 1600′ removing the white toner W remaining on the surface of the preprinting photosensitive drum 1300′, after the white toner W is settled on the surface of the metal material 100;
a preprinting photosensitive drum discharging unit 1420′ removing an charge from the preprinting photosensitive drum 1300′, after the white toner W is removed; and
a preprinting fixer 1700′ located on a rear end of the transfer belt 1800′, to fix the white toner W settled on the surface of the metal material 100.

4. The printing equipment of claim 1, wherein the main printing equipment 2000 comprises:
a main printing photosensitive drum 2300 transferring and settling a toner T attached to a surface of the main printing photosensitive drum 2300, to and on the surface of the metal material 100, while closely contacting a preprinted metal material 100 to rotate in one direction;
a main printing developer 2500 provided on one side of the main printing photosensitive drum 2300 and providing the toner T to the surface of the main printing photosensitive drum 2300;
a main printing photosensitive drum charging unit 2410 charging the surface of the main printing photosensitive drum 2300 before the toner T is provided;
a main printing exposure unit 2200 applying light energy to the surface of the main printing photosensitive drum 2300 according to a required image, between the main printing developer 2500 and the main printing photosensitive drum charging unit 2410;
a main printing metal material charging unit 2101 charging the surface of the metal material 100 such that the toner T attached to the surface of the main printing photosensitive drum 2300, to the surface of the metal material 100;
a main printing remover 2600 removing the toner T remaining on the surface of the main printing photosensitive drum 2300, after the toner T is settled on the surface of the metal material 100;
a main printing photosensitive drum discharging unit 2420 removing an charge from the main printing photosensitive drum 2300, after the toner T is removed; and
a main printing fixer 2700 located on a rear end of the main printing photosensitive drum 2300, to fix the toner T settled on the surface of the metal material 100.

5. The printing equipment of claim 1, wherein the main printing equipment 2000′ comprises:
a main printing transfer belt 2800′ transferring and settling a toner T attached to a surface of the main printing transfer belt 2800′, to and on the surface of the metal material 100, while closely contacting a preprinted metal material 100 to rotate in one direction;
a main printing photosensitive drum 2300′ transferring the toner T attached to a surface of the main printing photosensitive drum 2300′, to the surface of the main printing transfer belt 2800′, while closely contacting the main printing transfer belt 2800′ and rotating together with the main printing transfer belt 2800′ in an opposite direction;
a main printing developer 2500′ provided on one side of the main printing photosensitive drum 2300′ and providing the toner T to the surface of the main printing photosensitive drum 2300′;
a main printing photosensitive drum charging unit 2410′ charging the surface of the main printing photosensitive drum 2300′, before the toner T is provided;
a main printing exposure unit 2200′ applying light energy to the surface of the main printing photosensitive drum 2300′ according to a required image, between the main printing developer 2500′ and the main printing photosensitive drum charging unit 2410′;
a main printing metal material charging unit 2101′ charging the surface of the metal material 100 to transfer the toner T attached to the surface of the main printing transfer belt 2800′, to the surface of the metal material 100;
a main printing remover 2600′ removing the toner T remaining on the surface of the main printing photosensitive drum 2300′, after the toner T is settled on the surface of the metal material 100;
a main printing photosensitive drum discharging unit 2420′ removing an charge from the main printing photosensitive drum 2300′, after the toner T is removed; and
a main printing fixer 2700′ located on a rear end of the main printing transfer belt 2800′, to fix the toner T settled on the surface of the metal material 100.

6. The printing equipment of any one of claims 2 to 5, wherein a laser or an LED is used as the light energy.

7. The printing equipment of claim 6, wherein, when the light energy is the laser, the preprinting exposure unit (1200 and 1200′) and the main printing exposure unit (2200 and 2200′) comprise a laser generator and a scanning mirror.

8. The printing equipment of claim 3 or 5, comprising:
a transfer belt drive roll (1810′ and 2810′) driving the transfer belt (1800′ and 2800′) in a traveling direction;
a transfer belt charging unit (1820′ and 2820′) charging the transfer belt (1800′ and 2800′), before the transfer belt (1800′ and 2800′) receives the white toner W or the toner T;
a transfer belt toner remover (1840′ and 2840′) removing the toner T remaining on the transfer belt (1800′ and 2800′), after the white toner W or the toner T is transferred to the metal material 100; and
a transfer belt discharging unit (1830′ and 2830′) discharging the transfer belt, after the white toner W or the toner T is removed.

9. The printing equipment of any one of claims 2 to 5, wherein the remover (1600, 1600′, 2600, and 2600′) comprises a blade (1610, 1610′, 2610, and 2610′) and a collection bin (1842, 1842′, 2842, and 2842′) located on a lower end of the blade.

10. The printing equipment of claim 8, wherein the transfer belt toner remover (1840′ and 2840′) comprises a blade (1841′ and 2841′) and a collection bin (1842′ and 2842′) located on a lower end of the blade.

11. The printing equipment of any one of claims 2 to 5, wherein the developer (1500, 1500′, 2500, and 2500′) comprises a toner container (1520, 1520′, 2520, and 2520′) and a developing roller (1510, 1510′, 2510, and 2510′) providing a toner in the toner container to the photosensitive drum (1300, 1300′, 2300, and 2300′).

12. The printing equipment of any one of claims 2 to 5, wherein the fixer (1700, 1700′, 2700, and 2700′) comprises a fused roll (1710, 1710′, 2710, and 2710′) and a pressure roll (1720, 1720′, 2720, and 2720′).

13. The printing equipment of claim 4, wherein the main printing photosensitive drum, the main printing photosensitive drum charging unit, the main printing photosensitive drum discharging unit, the main printing exposure unit, the main printing developer, and the main printing remover are formed in pairs and are provided as two or more thereof in a traveling direction of the metal material 100, and
wherein each of the main printing developer provides a toner of a different color.

14. The printing equipment of claim 5, wherein the main printing photosensitive drum, the main printing photosensitive drum charging unit, the main printing photosensitive drum discharging unit, the main printing exposure unit, the main printing developer, and the main printing remover are formed in pairs and are provided as two or more thereof in a traveling direction of the transfer belt 2800′,
wherein each of the main printing developer provides a toner of a different color.

15. The printing equipment of claim 1, wherein the preprinting equipment and the main printing equipment are located on and below the metal material.

16. A printing method having excellent printing quality, comprising:
a preprinting operation of printing a white image on a surface of a metal material 100, which is continuously moving; and
a main printing operation of printing an image on a surface of the metal material 100 on which the white image is printed.

17. The method of claim 16, wherein the preprinting operation comprises:
a preprinting charging operation of charging a surface of a preprinting photosensitive drum 1300 rotating in one direction;
a preprinting exposure operation of applying light energy according to a required white image to a charged surface of the preprinting photosensitive drum 1300;
a preprinting development operation of providing a white toner W to the surface of the preprinting photosensitive drum 1300 after the exposure operation;
a preprinting transfer operation of moving and settling the white toner W attached to the surface of the preprinting photosensitive drum 1300 to a charged surface of the metal material 100;
a preprinting fixation operation of fixing the white toner W settled on the surface of the metal material 100;
a preprinting removal operation of removing the white toner W remaining on the surface of the preprinting photosensitive drum 300 after the transfer operation; and
a preprinting discharge operation of discharging the surface of the preprinting photosensitive drum 300.

18. The method of claim 16, wherein the preprinting operation comprises:
a preprinting charging operation of charging a surface of a preprinting photosensitive drum 1300′ rotating in one direction;
a preprinting exposure operation of applying light energy according to a required white image to a charged surface of the preprinting photosensitive drum 1300′;
a preprinting development operation of providing a white toner W to the surface of the preprinting photosensitive drum 1300′ after the exposure operation;
an operation of moving the white toner W attached to the surface of the preprinting photosensitive drum 1300′, to a charged surface of a preprinting transfer belt 1800′;
a preprinting transfer operation of moving and settling the toner attached to the surface of the preprinting transfer belt 1800′ to the charged surface of the metal material 100;
a preprinting fixation operation of fixing the white toner W settled on the surface of the metal material 100;
a preprinting removal operation of removing the white toner W remaining on the surface of the preprinting photosensitive drum 1300′ and the surface of the preprinting transfer belt 1800′ after the transfer operation; and
a preprinting discharge operation of discharging the surface of the preprinting photosensitive drum 1300′ and the surface of the preprinting transfer belt 1800′.

19. The method of claim 16, wherein the main printing operation comprises:
a main printing charging operation of charging a surface of a main printing photosensitive drum 2300 rotating in one direction;
a main printing exposure operation of applying light energy according to a required image to a charged surface of the main printing photosensitive drum 2300;
a main printing development operation of providing a toner T to the surface of the main printing photosensitive drum 2300 after the exposure operation;
a main printing transfer operation of moving and settling the toner T attached to the surface of the main printing photosensitive drum 2300 to a charged surface of the metal material 100;
a main printing fixation operation of fixing the toner T settled on the surface of the metal material 100;
a main printing removal operation of removing the toner T remaining on the surface of the main printing photosensitive drum 2300 after the transfer operation; and
a main printing discharge operation of discharging the surface of the main printing photosensitive drum 2300.

20. The method of claim 16, wherein the main printing operation comprises:
a main printing charging operation of charging a surface of a main printing photosensitive drum 2300′ rotating in one direction;
a main printing exposure operation of applying light energy according to a required image to a charged surface of the main printing photosensitive drum 2300′;
a main printing development operation of providing a toner T to the surface of the main printing photosensitive drum 2300′ after the exposure operation;
an operation of moving the toner attached to the surface of the main printing photosensitive drum 2300′, to a charged surface of a main printing transfer belt 2800′;
a main printing transfer operation of moving and settling the toner attached to the surface of the main printing transfer belt 2800′ to a charged surface of the metal material 100;
a main printing fixation operation of fixing the toner settled on the surface of the metal material 100;
a main printing removal operation of removing the toner remaining on the surface of the main printing photosensitive drum 2300′ and the surface of the main printing transfer belt 2800′ after the transfer operation; and
a main printing discharge operation of discharging the surface of the main printing photosensitive drum 2300′ and the surface of the main printing transfer belt 2800′.

21. The method of any one of claims 17 to 20, wherein the preprinting fixation operation or the main printing fixation operation is performed by heating to 25 to 400° C.

22. The method of any one of claims 17 to 20, wherein the preprinting fixation operation or the main printing fixation operation further comprises a pressing operation.

23. The method of claim 19 or 20, wherein the main printing operation requires two or more main printing photosensitive drums when printing using two or more toners,
wherein the main printing charging operation, the main printing exposure operation, the main printing development operation, the main printing transfer operation, and the main printing removal operation are provided in two or more, and are performed using each of the main printing photosensitive drums.

24. A printed metal material having excellent printing quality, comprising:
a metal material;
a white image layer formed on the metal material; and
a printing layer formed on the white image layer.

25. The printed metal material of claim 24, manufactured using the printing equipment of any one of claims 1 to 5.

26. The printed metal material of claim 24, manufactured by the method of any one of claims 16 to 20.

27. The printed metal material of claim 24, further comprising a coating layer between the metal material and the white image layer.

28. The printed metal material of claim 27, wherein the coating layer is an electrogalvanized (EG) layer or a hot-dip galvanized (GI) layer.

29. The printed metal material of claim 28, wherein the coating layer comprises a pretreatment layer formed on the electrogalvanized (EG) layer or hot dip galvanized (GI) layer, an intermediate coating layer formed on the pretreatment layer, and an upper coating layer formed on the intermediate coating layer.

30. The printed metal material of claim 27, further comprising a transparent coating layer formed on the printing layer.
